(19) United States
(12) Patent Application Publication
(10) Pub. No.: US 2009/0231954 A1
(43) Pub. Date: Sep. 17, 2009

(54) Micro-Annulus Detection Using Lamb Waves

(75) Inventors: Alexei Bolshakov, Pearland, TX (US); Edward J. Domangue, Houston, TX (US); Douglas J. Patterson, Spring, TX (US)

Correspondence Address: MADAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 12/049,515

(22) Filed: Mar. 17, 2008

(51) Int. Cl. G01V 1/40

(52) U.S. Cl. 367/35

(57) ABSTRACT

A method, apparatus and computer-readable medium for identifying a micro-annulus outside a casing in a cemented wellbore. The attenuation of a Lamb wave and a compressional wave is used to determine a presence of a micro-annulus between the casing and the cement.

### BACKGROUND OF THE DISCLOSURE

1. Field of the Disclosure

The disclosure relates generally to determining an integrity of cement between a casing in a wellbore in a formation and the surrounding formation. More specifically, the present disclosure relates to a method of detecting the presence of micro-annular gaps using Lamb waves within a wellbore casing.

2. Description of Related Art

As illustrated in FIG. 1 wellbores typically include casing 8 set within the wellbore 5, where the casing 8 is bonded to the wellbore by adding cement 9 within the annulus formed between the outer diameter of the casing 8 and the inner diameter of the wellbore 5. The cement bond not only adheres to the casing 8 within the wellbore 5, but also serves to isolate adjacent zones (e.g. Z₁ and Z₂) within an earth formation 18. Isolating adjacent zones can be important when one of the zones contains oil or gas and the other zone includes a non-hydrocarbon fluid such as water. Should the cement 9 surrounding the casing 8 be defective and fail to provide isolation of the adjacent zones, water or other undesirable fluid can migrate into the hydrocarbon producing zone thus diluting or contaminating the hydrocarbons within the producing zone, and increasing production costs, delaying production or inhibiting resource recovery.

To detect possible defective cement bonds, downhole tools 14 have been developed for analyzing the integrity of the cement 9 bonding the casing 8 to the wellbore 5. These downhole tools 14 are lowered into the wellbore 5 by wireline 10 in combination with a pulley 12 and typically include transducers 16 disposed on their outer surface formed to be acoustically coupled to the fluid in the borehole. These transducers 16 are generally capable of emitting acoustic waves into the casing 8 and recording the amplitude of the acoustic waves as they travel, or propagate, across the casing 8. Typically the transducers 16 are piezoelectric devices having a piezoelectric crystal that converts electrical energy into mechanical vibrations or oscillations transmitting acoustic wave to the casing 8. Characteristics of the cement bond, such as its efficacy, integrity and adherence to the casing, can be determined by analyzing characteristics of the received acoustic wave such as attenuation. See, for example, U.S. Pat. No. 6,483,777 to Zeroug, U.S. Pat. No. 4,805,156 to Attali et al., and U.S. Pat. No. 7,311,143 to Engels et al.

The state of the casing can generally be separated into one of three categories: a free pipe state, a cemented pipe state in which cement bonds the casing to the formation, and a micro-annulus state in which the cement region has one or more micro-annular gaps. The presence of a micro-annular gap can indicate a weakened cementing of the casing to the formation. Prior art methods have not addressed the problem of identification of a micro-annulus. The present disclosure addresses this problem.

### SUMMARY OF THE DISCLOSURE

In one aspect, the present disclosure provides a method of identifying a micro-annulus outside a casing in a cemented wellbore. The method includes the elements of propagating a first acoustic wave and a second acoustic wave in the casing; estimating a first attenuation of the first propagating acoustic wave and a second attenuation of the second propagating acoustic wave; and determining from the first attenuation and the second attenuation a presence of a micro-annulus between the casing and the cement. In one aspect, the first acoustic wave may be a Lamb wave and the second acoustic wave may be a P-wave. The first attenuation may be compared to the attenuation of a Lamb wave in a cased wellbore without a micro-annulus. Additionally, the second attenuation may be compared to the attenuation of a P-wave for a free pipe. In one aspect, the first acoustic wave and the second acoustic wave may be produced using an either Electromagnetic Acoustic Transducer (EMAT) or a piezoelectric device. Estimating the first attenuation may include using amplitudes of the first propagating acoustic wave at a plurality of spaced-apart receivers, and estimating the second attenuation may include using amplitudes of the second propagating acoustic wave at a plurality of spaced apart receivers. Estimating the first attenuation and second attenuation and determining a presence of a micro-annulus may occur at either a downhole location or a surface location.

In another aspect, the present disclosure provides an apparatus for identifying a micro-annulus outside a casing in a cemented wellbore. The apparatus includes an acoustic wave generator in contact with an inner diameter of the casing configured to propagate a first acoustic wave and a second acoustic wave in the casing; at least one receiver configured to receive the first and second acoustic waves upon propagation in the casing; and a processor configured to: (a) estimate a first attenuation of the first propagating acoustic wave and a second attenuation of the second propagating acoustic wave; and (b) determine from the first attenuation and the second attenuation a presence of a micro-annulus between the casing and the cement. In one aspect, the first acoustic wave is a Lamb wave and the second acoustic wave is a P-wave. The processor is configured to compare the first attenuation to the attenuation of a Lamb wave in a cased wellbore without the micro-annulus. The processor is also configured to compare the second attenuation to the attenuation of a P-wave for a free pipe. In one aspect, the acoustic wave generator may be an Electromagnetic Acoustic Transducer (EMAT) or a piezoelectric device. In one aspect, the at least one receiver includes a plurality of spaced-apart receivers, and the processor is configured to estimate the first attenuation using amplitudes of the first propagating acoustic wave at the plurality of spaced-apart receivers and to estimate the second attenuation using amplitudes of the second propagating acoustic wave at the plurality of spaced-apart receivers. The processor may be located at a downhole location or a surface location.

In another aspect, the present disclosure provides a computer-readable medium for use with an apparatus for identifying a micro-annulus outside a casing in a cemented wellbore, wherein the apparatus includes an acoustic wave generator in contact with an inner diameter of the casing configured to propagate a first acoustic wave and a second acoustic wave in the casing; and at least one receiver configured to receive one or both of the first and second acoustic waves upon propagation in the casing. The medium includes instructions which when executed by a processor enable the processor to (a) estimate a first attenuation of the first propagating acoustic wave and a second attenuation of the second propagating acoustic wave; and (b) determine from the first attenuation and the second attenuation a presence of a micro-annulus between the casing and the cement. The medium may be at least one of (i) a ROM, (ii) a CD-ROM, (iii) an EPROM, (iv) an EAROM, (v) a flash memory, and (vi) an optical disk.

### BRIEF DESCRIPTION OF THE DRAWINGS

The present disclosure and its advantages will be better understood by referring to the following detailed description and the attached drawings in which:

FIG. 1 (Prior Art) depicts a partial cross section of prior art downhole cement bond log tool disposed within a wellbore;

FIGS. 2A-2B (Prior Art) schematically illustrate a magnetic coupling transmitter disposed to couple to a section of casing;

FIG. 3 (Prior Art) shows one embodiment of an apparatus disposed within a wellbore suitable for use with the method of the present disclosure;

FIGS. 4A-4D (Prior Art) depict alternative embodiments of apparatus suitable for use with the method of the present disclosure;

FIG. 5A depicts a top-view of a casing of the present disclosure disposed in a borehole having acoustic wave generators within;

FIG. 5B depicts a close-up of the interface of the casing and the formation

FIG. 6 illustrates an exemplary wave form creatable at an acoustic transducer for propagation in a casing;

FIGS. 7-8 illustrate waveforms and windows used for calculating P-wave and Lamb wave attenuations;

FIG. 9 depicts Lamb and P-wave attenuation values obtained from at various casing states;

FIG. 10 shows a cement model usable for investigating probe responses to different size of micro annulus; and

FIG. 11 displays data taken with an A0 mode of a Lamb probe in the micro-annulus model of FIG. 10.

While the disclosure will be described in connection with its exemplary embodiments, it will be understood that the disclosure is not limited thereto. It is intended to cover all alternatives, modifications, and equivalents which may be included within the spirit and scope of the disclosure, as defined by the appended claims.

### DETAILED DESCRIPTION OF THE DISCLOSURE

Changes in ultrasonic wave propagation speed, along with energy losses from interactions with materials microstructures are often used to nondestructively gain information about properties of the material. An ultrasonic wave, such as a Lamb wave or a shear horizontal (SH) wave, may be created in a material sample, such as a solid beam, by creating an impulse at one region of the sample. As the wave propagates through the casing, the casing state with respect to the formation affects the wave. Once the affected wave is recorded, the casing state can be determined.

The amount of attenuation can depend on how an acoustic wave is polarized and the coupling condition between the casing and the cement. Typical downhole tools having acoustic wave transducers generate acoustic waves that are polarized perpendicular to the surface of the casing. The attenuation of the acoustic wave as it propagates along the surface of the casing depends on the condition of the cement bond and is also dependent on the type of cement disposed between the casing and the formation. More specifically, as the acoustic wave propagates along the length of the casing, the wave loses, or leaks, energy into the formation through the cement bond—it is this energy loss that produces the attenuation of the acoustic wave. Conversely, when the casing is not bonded, a condition also referred to as “free pipe,” the micro-annulus fluid outside the casing does not provide for any shear coupling between the casing and the formation. Loss of shear coupling significantly reduces the compressional coupling between the casing and the formation. This result occurs since fluid has no shear modulus as well as a much lower bulk modulus in relation to cement.

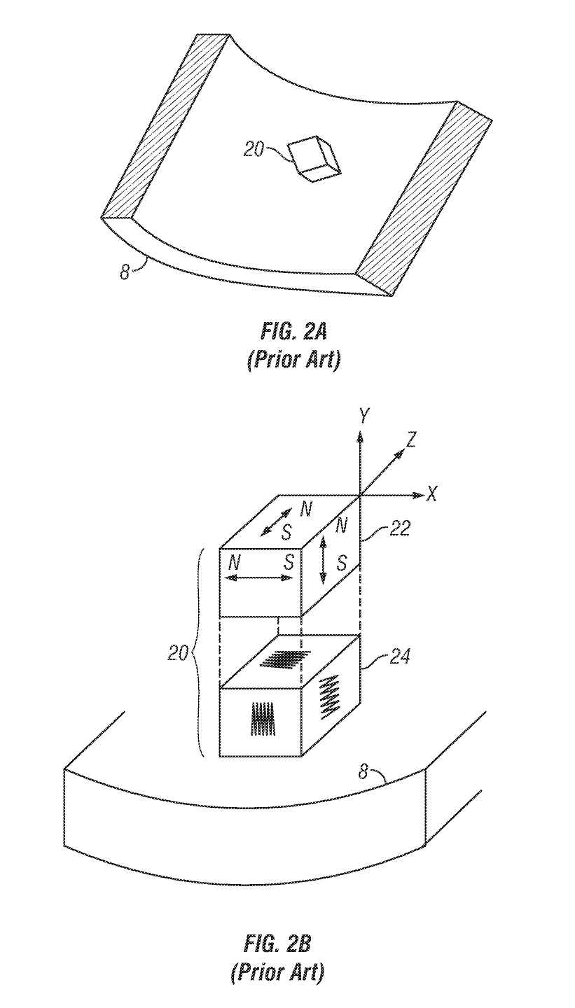

As illustrated in FIG. 2A, a magnetically coupled transducer 20 is positioned at any desired attitude proximate to a section of casing 8. For the purposes of clarity, only a portion of the length and diameter of a section of casing 8 is illustrated and the magnetically coupled transducer 20 is shown schematically in both FIG. 2A and FIG. 2B. The magnetically coupled transducer 20 may be positioned within the inner circumference of the tubular casing 8, but the magnetically coupled transducer 20 can also be positioned in other areas.

For any particular transducer 20, more than one magnet (of any type for example permanent, electromagnetic, etc.) may be combined within a unit; such a configuration enables inducing various waveforms and facilitating measurement and acquisition of several waveforms. A transducer 20 capable of transmitting or receiving waveforms in orthogonal directions is schematically illustrated in FIG. 2B. While a schematic magnet 22 with orthogonal magnetic fields is illustrated, a single-field relatively large magnet with multiple smaller coils 24 (which coils may be disposed orthogonally) may be employed to form versatile transducers.

In embodiments provided by the present disclosure that are illustrated schematically in FIGS. 2A and 2B, the magnetically coupled transducer 20 includes a magnet 22 and a coil 24, where the coil 24 is positioned between the magnet 22 and the inner circumference of the casing 8. An electrical current source (not shown) is connectable to the coil 24 capable of providing electrical current to the coil 24. The magnet 22, may be one or more permanent magnets in various orientations or can also be an electromagnet, energized by either direct or alternating current. FIG. 2B schematically illustrates orthogonal magnetic and coil representations. One or more magnets or coils may be disposed within a downhole tool to affect desired coupling and/or desired wave forms such as the direct inducing of shear waves into casing 8. While the coil is illustrated as disposed between the magnet and the casing, the coil may be otherwise disposed adjacent to the magnet.

The coil 24 may be energized when the magnetically coupled transducer 20 is proximate to the casing 8 to produce acoustic waves within the material of the casing 8. For example the coil may be energized with a modulated electrical current. Thus the magnetically coupled transducer 20 operates as an acoustic transmitter.

The magnetically coupled transducer 20 can also operate as a receiver capable of receiving waves that have traversed the casing and cement. The magnetically coupled transducer 20 may be referred to as an acoustic device. As such, the acoustic devices of the present disclosure function as acoustic transmitters or as acoustic receivers, or as both. An exemplary acoustic device usable in the present disclosure may include an Electromagnetic-acoustic transducer (EMAT). Various EMAT design configurations have been used in the art, such as disclosed in U.S. Pat. No. 4,296,486 to Vasile, U.S. Pat. No. 7,024,935 to Paige et al. and U.S. patent application Ser. No. 11/748,165 of Reiderman et al., having the same assignee as the present disclosure and the contents of which are incorporated herein by reference. Alternatively, a piezoelectric acoustic device may be used.

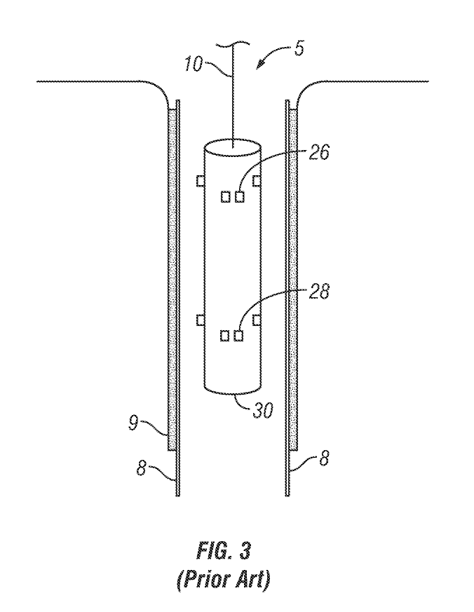

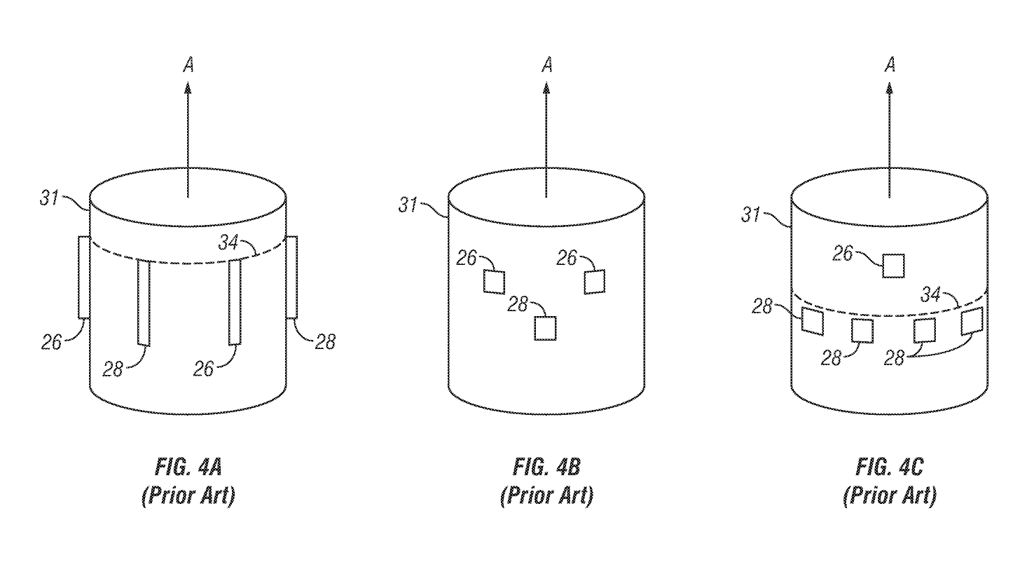

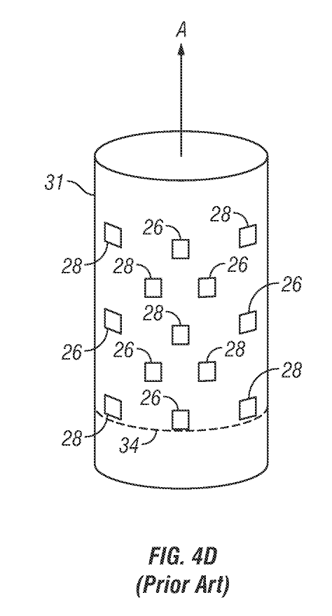

The present disclosure as illustrated in FIG. 3 provides a sonde 30 shown having acoustic devices disposed on its outer surface. The acoustic devices include a series of acoustic transducers, both transmitters 26 and receivers 28, where the distance between each adjacent acoustic device on the same row may be substantially the same. With regard to the configuration of acoustic transmitters 26 and acoustic receivers 28 shown in FIG. 3, while the rows 34 radially circumscribing the sonde 30 can include any number of acoustic devices (i.e. transmitters 26 or receivers 28), it is preferred that each row 34 include five or more of these acoustic devices (the preference for five or more devices is for devices with the transmitters and receivers radially arranged around the circumference e.g., FIG. 4A). The acoustic transmitters 26 may be magnetically coupled transducers 20 of the type of FIGS. 2A and 2B including a magnet 22 and a coil 24. Optionally, the acoustic transmitters 26 can include electromagnetic acoustic transducers.

Referring now again to the configuration of the acoustic transmitters 26 and acoustic receivers 28 of FIG. 3, the acoustic transducers including transmitters 26 and receivers 28 can be arranged in at least two rows where each row includes primarily acoustic transmitters 26 and a next adjacent row includes primarily acoustic receivers 28. Optionally, as shown in FIG. 3, the acoustic devices within adjacent rows in this arrangement are aligned in a straight line along the length of the sonde 30.

While only two circumferential rows 34 of acoustic devices are shown in FIG. 3, variations and placement of transducers and arrangements in rows can be included depending on the capacity and application of the sonde 30. Another arrangement is to have one row of acoustic transducers 26 followed by two circumferential rows of acoustic receivers 28 followed by another row of acoustic transducers 26. As is known in the art, advantages of this particular arrangement include the ability to make a self-correcting acoustic measurement. Attenuation measurements are made in two directions using arrangements of two transmitters and two receivers for acquisition of acoustic waveforms. The attenuation measurements may be combined to derive compensated values that do not depend on receiver sensitivities or transmitter power.

Additional arrangements of the acoustic transducers 26 and acoustic receivers 28 disposed on a sonde 31 are illustrated in a series of non-limiting examples in FIGS. 4A through 4D. In the embodiment of FIG. 4A a row of alternating acoustic transducers, transmitters 26 and receivers 28 are disposed around the sonde 31 at substantially the same elevation. The acoustic devices may be equidistantly disposed around the axis A of the sonde section 31. In an alternative configuration of the present disclosure shown in FIG. 4B, the acoustic devices are disposed in at least two rows around the axis A of the sonde section 31, but unlike the arrangement of the acoustic devices of FIG. 3, the acoustic devices of adjacent rows are not aligned along the length of the sonde 30, but instead are staggered.

FIG. 4C illustrates a configuration where a single acoustic transmitter 26 cooperates with a group or groups of acoustic receivers 28. Optionally the configuration of FIG. 4C can have from 6 to 8 receivers 28 for each transmitter 26. FIG. 4D depicts rows of acoustic transducers where each row includes a series of alternating acoustic transducers 26 and acoustic receivers 28. The configuration of FIG. 4D is similar to the configuration of FIG. 4B in that the acoustic devices of adjacent rows are not aligned but instead are staggered. It should be noted however that the acoustic devices of FIG. 4D may be staggered in a way that a substantially helical pattern (44) is formed by acoustic devices around the sonde. The present disclosure is not limited in scope to the configurations displayed in FIGS. 4A through 4D, and other arrangements will occur to practitioners of the art and are contemplated within the scope of the present disclosure.

In operation of one embodiment of the present disclosure, a series of acoustic transmitters 26 and acoustic receivers 28 are included on a sonde 30 (or other downhole tool). The sonde 30 is then secured to a wireline 10 and deployed within a wellbore 5 for evaluation of the casing 8, casing bond, and/or formation 18. When the sonde 30 is within the casing 8 and proximate to the region of interest, the electrical current source can be activated thereby energizing the coil 24. Providing current to the coil 24 via the electrical current source produces eddy currents within the surface of the casing 8 as long as the coil 24 is sufficiently proximate to the wall of the casing 8. It is within the capabilities of those skilled in the art to situate the coil 24 sufficiently close to the casing 8 to provide for the production of eddy currents within the casing 8. Inducing eddy currents in the presence of a magnetic field imparts Lorentz forces onto the particles conducting the eddy currents that in turn causes oscillations within the casing 8 thereby producing waves within the wall of the casing 8. The coil 24 of the present disclosure can be of any shape, design, or configuration as long as the coil 24 is capable of producing an eddy current in the casing 8.

Accordingly, the magnetically coupled transducer 20 is magnetically “coupled” to the casing 8 by virtue of the magnetic field created by the magnetically coupled transducer 20 in combination with the eddy currents provided by the energized coil 24. Thus one of the many advantages of the present disclosure is the ability to provide coupling between an acoustic wave producing transducer without the requirement for the presence of liquid medium. Additionally, these magnetically induced acoustic waves are not hindered by the presence of dirt, sludge, scale, or other like foreign material as are traditional acoustic devices, such as piezoelectric devices.

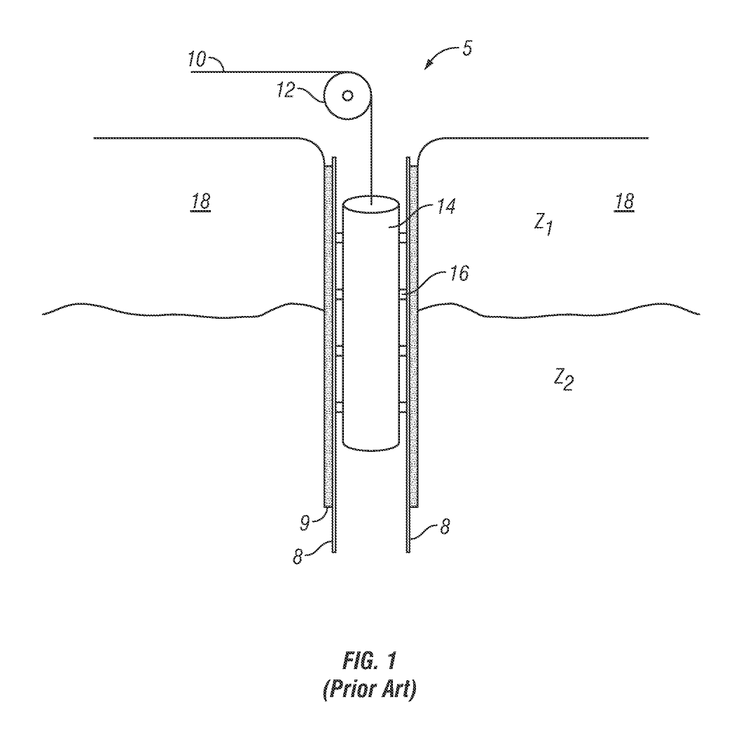

The waves induced by combining the magnet 22 and energized coil 24 propagate through the casing 8. These acoustic waves can further travel from within the casing 8 through the cement 9 and into the surrounding formation 18. At least a portion of these waves can be reflected or refracted upon encountering a discontinuity of material, either within the casing 8 or the area surrounding the casing 8. Material discontinuities include the interface where the cement 9 is bonded to the casing 8 as well as where the cement 9 contacts the earth formation (e.g. Z₁ and Z₂ of FIG. 1). Other discontinuities can be casing seams or defects, or even damaged areas of the casing such as pitting or corrosion.

As is known, the waves that propagate through the casing 8 and the reflected waves are often attenuated with respect to the wave as originally produced. The acoustic wave characteristic most often analyzed for determining casing and cement adhesion is the attenuation of the transmitted waves that have traversed portions of the casing 8 and/or cement 9. Analysis of the amount of wave attenuation can provide an indication of the integrity of a casing bond (i.e. the efficacy of the cement 9), the casing thickness, and casing integrity. The reflected waves and the waves that propagate through the casing 8 can be recorded by receiving devices disposed within the wellbore 5 and/or on the sonde. The sonde 30 may contain memory for data storage and a processor for data processing. If the sonde 30 is in operative communication with the surface through the wireline 10, the recorded acoustic waves can be subsequently conveyed from the receivers to the surface for storage, analysis and study.

An additional advantage of the present design includes the flexibility of producing and recording more than one type of waveform. The use of variable waveforms can be advantageous since one type of waveform can provide information that another type of waveform does not contain. Thus the capability of producing multiple types of waveforms in a bond log analysis can in turn yield a broader range of bond log data as well as more precise bond log data. With regard to the present disclosure, not only can the design of the magnet 22 and the coil 24 be adjusted to produce various waveforms, but can also produce numerous wave polarizations.

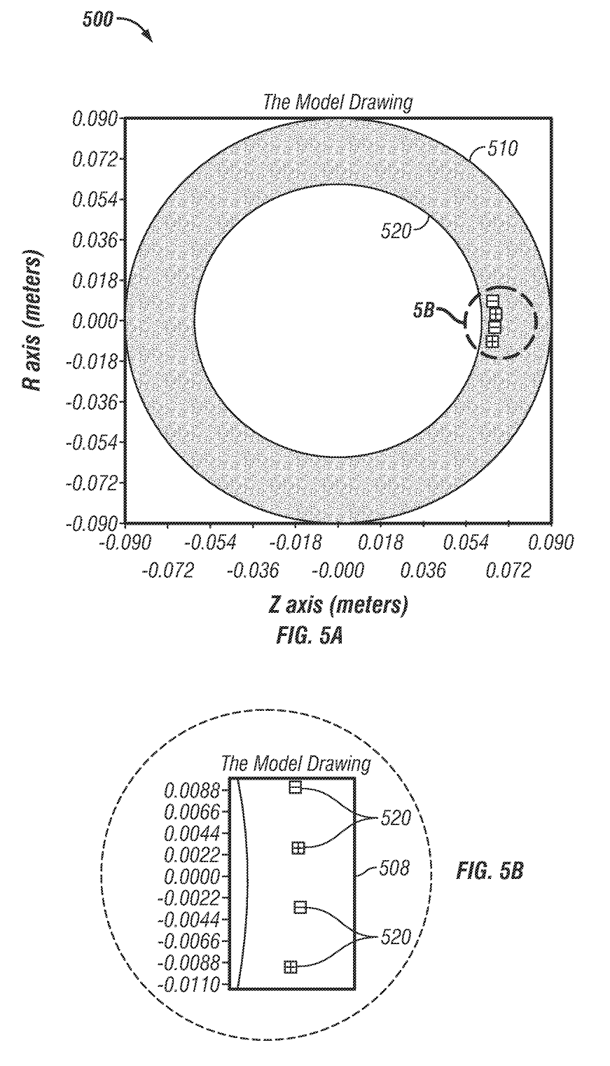

FIG. 5A illustrates a top-view of a casing of the present disclosure disposed in a borehole having acoustic wave generators within. Casing 510 is shown disposed in formation 505. The casing has one or more source nodes 520 disposed within for generating acoustic waves. FIG. 5B illustrates a close-up of the interface of the casing and the formation. A micro-annular region 508 is shown between casing and formation.

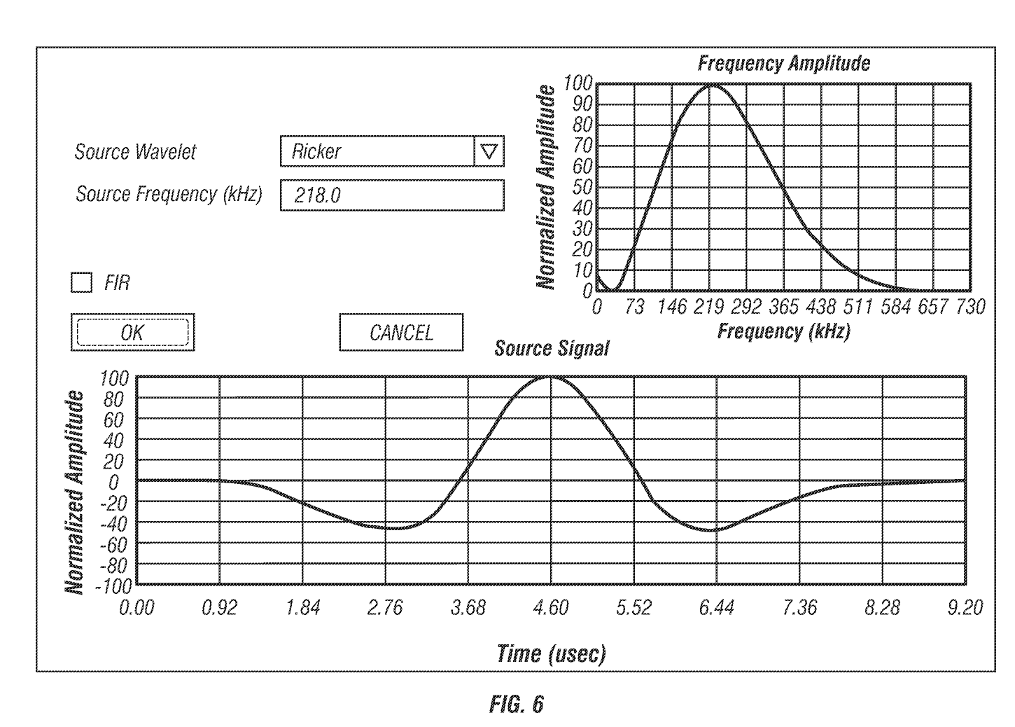

FIG. 6 illustrates an exemplary wave form 601 creatable at an acoustic transducer for propagation in the casing of FIG. 5. A frequency distribution 603 of the wave form 601 is also shown.

Lamb waves excited in the casing can be used to detect and identify the cemented casing state in an oil or gas well: (a) cemented pipe (i.e. casing with cement at its outer diameter (OD)); (b) free pipe (i.e. casing with fluid at its OD); and (c) micro annulus (i.e. casing with cement at its OD separated from pipe by a thin film of fluid). In one aspect of the present disclosure, a first acoustic wave and a second acoustic wave are propagated in the casing. A first attenuation is estimated for the first propagating acoustic wave and a second attenuation is estimated for the second propagating acoustic wave. The presence of a micro-annulus is determined from the first and second attenuations. The acoustic wave may be generated, for instance, at a source node 520, which may be an acoustic wave generator such as an EMAT or piezoelectric wave generator. In general, the first acoustic wave may be a Lamb wave and the second acoustic wave may be a P-wave. The Lamb wave is also referred to as the A0 mode.

A cemented pipe generally shows a higher attenuation of both the A0 and P-wave modes than does a free pipe. In the case of waves propagating through a casing with a micro annular gaps in the cement, the attenuation of the P-wave is similar to that seen for P-waves propagating in a free pipe, and attenuation of the Lamb wave is similar to that seen for A0 modes propagating in a cemented pipe. Thus, given a thin film of fluid in a micro-annular region, the Lamb wave can see cement through the thin film of fluid.

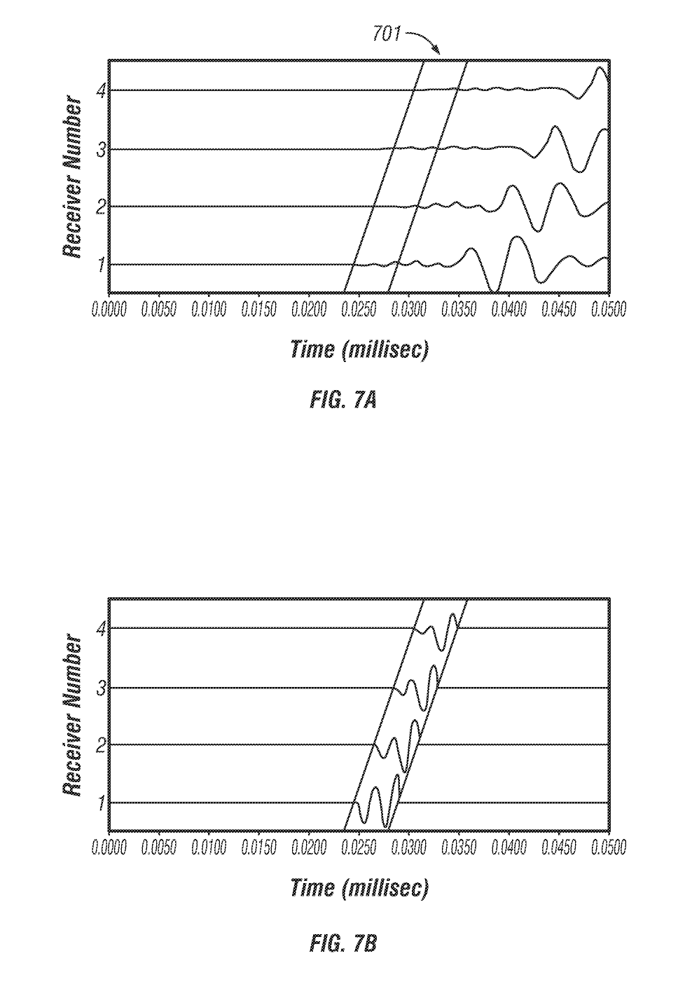

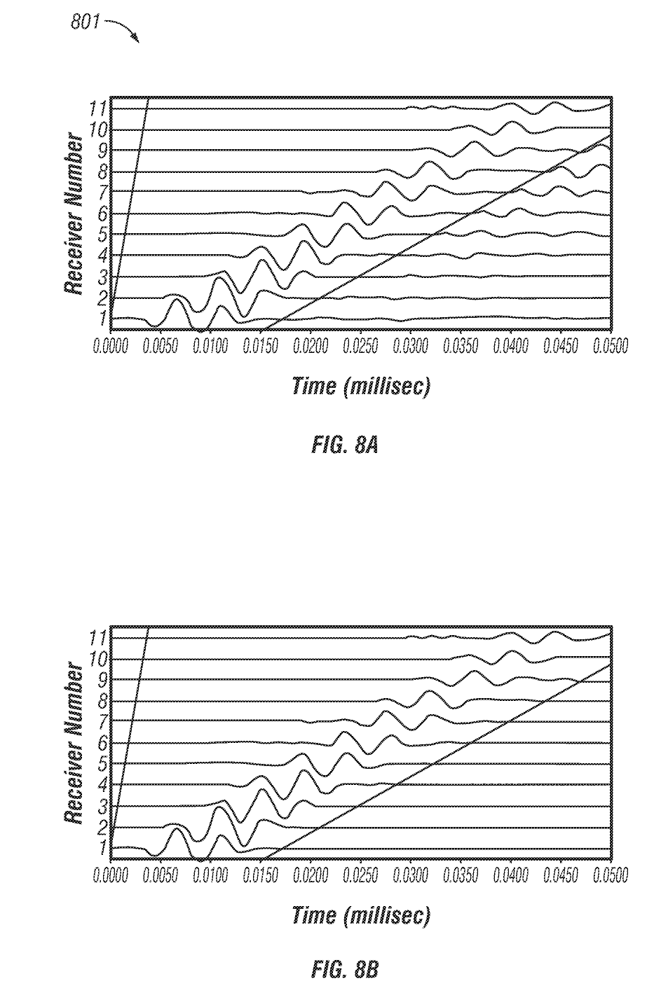

FIGS. 7A-7B and 8A-8B illustrate various receiver measurements usable for calculating P-wave and Lamb wave attenuations. Measurements obtained at the spaced-apart receivers are used to determine the attenuation of the propagated acoustic wave. FIG. 7A shows measurements of a P-mode waveform as recorded at several receivers (receivers 1-4). Receiver numbers are shown along the y-axis and time is shown along the x-axis in milliseconds. A measurement window is superimposed over the recorded waveforms. Receivers may be spaced apart along the casing. In the illustrative embodiment of FIGS. 7A-7B, receiver-to-receiver distance is 0.0355 ft, and the distance from the center of the transmitter to the receivers is 0.355 ft. The distances are measured along the circumference. FIG. 7B illustrates a portion of the waveforms of FIG. 7A as seen through the measurement window 701 corresponding to the P-wave arrival. The portion of the waveforms shown in FIG. 7B may be used to determine P-wave attenuation.

For the purposes of the present disclosure, we estimate the attenuation simply by measuring the peak amplitudes of the signals at the different receiver locations. This gives the attenuation in terms of dB/ft. or dB/cm. With the signals of limited bandwidth used in the present disclosure, this definition of attenuation is similar to the more commonly defined attenuation in terms of dB/wavelength. The latter requires analysis in the frequency domain, and over the short distances in the tool and the narrow bandwidth, the spectral estimation of attenuation may be difficult.

FIG. 8A shows measurements of a Lamb mode waveform 801 as recorded at several receivers 1-11. Receiver numbers are shown along the y-axis and time is shown along the x-axis in milliseconds. A measurement window used for calculating of the Lamb-wave attenuation is superimposed over the waveforms. Receivers may be spaced apart along the casing. In the illustrative embodiment of FIGS. 8A-8B, receiver-to-receiver distance is 0.0355 ft, and the distance from the center of the transmitter to the receivers is 0.355 ft. The distances are measured along the circumference. FIG. 8B illustrates a portion of the waveforms of FIG. 8A as seen through the measurement window. The portion of the waveforms shown in FIG. 8B may be used to determine Lamb wave attenuation.

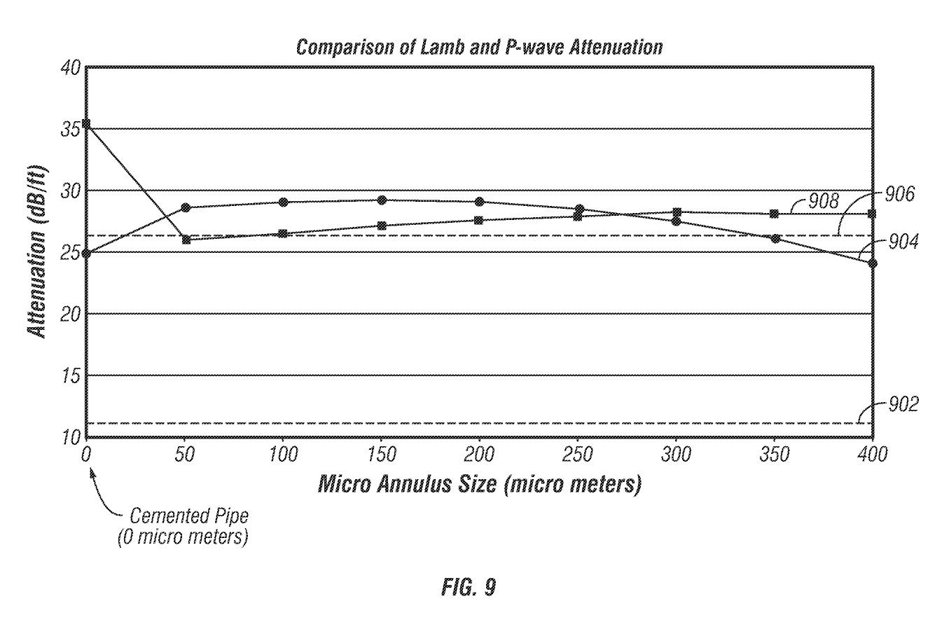

FIG. 9 shows a comparison of Lamb and P-wave attenuation values obtained from several models of casing states. The cement used has the following properties: ρ=1.965 g/cc, P-wave velocity Vₚ=3150 m/s, S-wave velocity Vₛ=1688 m/s, and Poisson's ratio=0.3. Results are shown for ten models: one model using a free pipe, one model using a cemented pipe, and 8 micro-annulus models. The results from the micro-annulus models are displayed for micro-annulus sizes varying from 0.05 mm to 0.400 mm by steps of 0.05 mm. The attenuation is shown along the y-axis in decibels per feet (dB/ft) and the size of the micro-annulus in the cement region is shown along the x-axis in micrometers. A micro-annulus state of 0 micrometers corresponds to a cemented pipe state. Free pipe measurements are shown as lines 902 and 906 for comparison with results at each of the micro-annular models. Curve 902 shows Lamb wave attenuation for a free pipe of an acoustic signal having a frequency centered at 210 kHz. Curve 906 shows P-wave attenuation for a free pipe of an acoustic signal having a frequency centered at 80 kHz. Curve 904 shows attenuation for a Lamb wave propagating at 210 kHZ for several micro-annular models. Curve 908 shows P-wave attenuation for a p-wave propagating at 80 kHz for several micro-annular models. As seen in FIG. 9, the P-wave arrival attenuation is similar to the response of a free pipe. Meanwhile, the Lamb component attenuation is similar to the response of a fully cemented pipe.

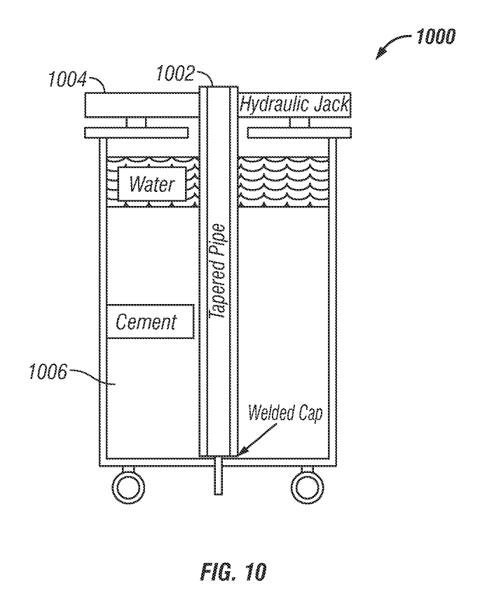

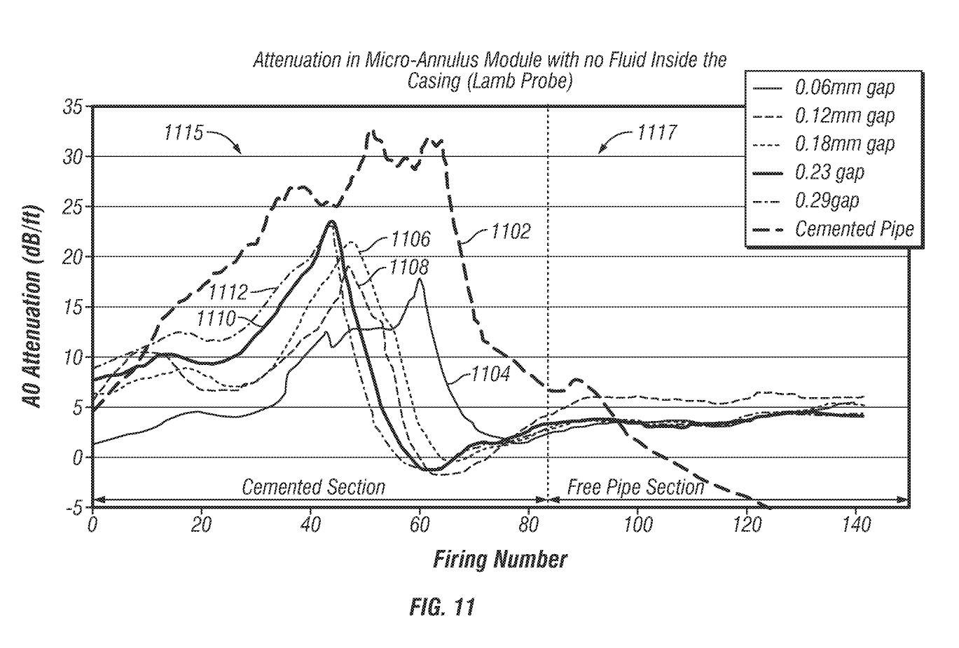

FIG. 10 shows a cement model 1000 usable for investigating probe responses to different sizes of a micro-annulus. The model includes a tapered pipe 1002 which OD is linearly increasing from the bottom to the top of the model. This pipe is moved up and down by a hydraulic jack 1004, thus creating a larger or smaller gap between the OD of the pipe and surface of cement 1006. A section of free pipe at the top provides a reference type. Typically, a probe starts at the bottom and is pulled to the top of the model, firing and acquiring data in the process. Due to the presence of a free pipe section in all the models, the difference in probe responses to the casing with micro annulus or fully bonded cement and to the free pipe can be analyzed.

FIG. 11 displays data taken with an A0 mode of a Lamb probe in the micro-annulus model of FIG. 10. Firing number is shown along the x-axis, and A0 mode attenuation is shown along the y-axis. Responses in the cemented region 1115 of the casing and the free pipe section 1117 of the casing are displayed. Curve 1102 represents data in the model after cementing and before the casing is moved, i.e. fully cemented model. The value of the attenuation at the top of this curve (around 35 dB/ft) is in general agreement with the modeled value of A0 mode attenuation in the cemented pipe shown in FIG. 9 (35 dB/ft at 0 mm of micro annulus). Attenuation is present for all values of micro annulus gap, even with a micro annulus of 0.29 mm. Curves 1104-1112 show attenuation data obtained in models with 0.06 mm gap, 0.12 mm gap, 0.18 mm gap, 0.23 mm gap, and 0.29 mm gap, respectively. The data is offset from curve to curve due to variations in the exact start time and velocity used to transport the instrument up the casing. There is a nevertheless a high degree of similarity between all curves. The attenuations observed tend to get larger as the micro annulus also gets larger. The last two stations, however (Curves 1110 and 1112 of 0.23 and 0.29 mm of micro annulus) seem to converge. The last curve 1112 (0.29 mm) illustrates attenuation measured for the largest micro annulus creatable using the model of FIG. 10. All of the attenuations recorded for different values of micro annulus are less than the attenuations obtained for the fully cemented model. Thus, the attenuation of the Lamb wave along the casing can be used to determine the presence of a micro-annulus.

Implicit in the control and processing of the data is the use of a computer program on a suitable machine readable medium that enables the processor to perform the control and processing. The machine readable medium may include ROMs, EPROMs, EEPROMs, Flash Memories and Optical disks. Such a computer program may output the results of the processing to a suitable tangible medium. This may include a display device and/or a memory device.

The present disclosure described herein, therefore, is well adapted to carry out the objects and attain the ends and advantages mentioned, as well as others inherent therein. While a presently preferred embodiment of the disclosure has been given for purposes of disclosure, numerous changes exist in the details of procedures for accomplishing the desired results. These and other similar modifications will readily suggest themselves to those skilled in the art, and are intended to be encompassed within the spirit of the present disclosure herein and the scope of the appended claims.

What is claimed is:

1. A method of identifying a micro-annulus outside a casing in a cemented wellbore, the method comprising:
propagating a first acoustic wave and a second acoustic wave in the casing;
estimating a first attenuation of the first propagating acoustic wave and a second attenuation of the second propagating acoustic wave; and
determining from the first attenuation and the second attenuation a presence of a micro-annulus between the casing and the cement.

2. The method of claim 1, wherein the first acoustic wave comprises a Lamb wave and the second acoustic wave comprises a P-wave.

3. The method of claim 2, further comprising comparing the first attenuation to the attenuation of a Lamb wave in a cased wellbore without the micro-annulus.

4. The method of claim 2 further comprising comparing the second attenuation to the attenuation of a P-wave for a free pipe.

5. The method of claim 1 further comprising producing the first acoustic wave and the second acoustic wave using one of: (A) an Electromagnetic Acoustic Transducer (EMAT), and (B) a piezoelectric device.

6. The method of claim 1, wherein estimating the first attenuation further comprises using amplitudes of the first propagating acoustic wave at a plurality of spaced-apart receivers, and wherein estimating the second attenuation further comprises using amplitudes of the second propagating acoustic wave at a plurality of spaced apart receivers.

7. The method of claim 1, wherein estimating the first attenuation and second attenuation and determining a presence of a micro-annulus occurs at one of: i) a downhole location, and ii) a surface location.

8. An apparatus for identifying a micro-annulus outside a casing in a cemented wellbore, the apparatus comprising:
an acoustic wave generator in contact with an inner diameter of the casing configured to propagate a first acoustic wave and a second acoustic wave in the casing;
at least one receiver configured to receive the first and second acoustic waves upon propagation in the casing; and
a processor configured to:
(a) estimate a first attenuation of the first propagating acoustic wave and a second attenuation of the second propagating acoustic wave; and
(b) determine from the first attenuation and the second attenuation a presence of a micro-annulus between the casing and the cement.

9. The apparatus of claim 8, wherein the first acoustic wave comprises a Lamb wave and the second acoustic wave comprises a P-wave.

10. The apparatus of claim 9, wherein the processor is further configured to compare the first attenuation to the attenuation of a Lamb wave in a cased wellbore without the micro-annulus.

11. The method of claim 9, wherein the processor is further configured to compare the second attenuation to the attenuation of a P-wave for a free pipe.

12. The apparatus of claim 8, wherein the acoustic wave generator is one of: (A) an Electromagnetic Acoustic Transducer (EMAT), and (B) a piezoelectric device.

13. The apparatus of claim 8, wherein the at least one receiver further comprises a plurality of spaced-apart receivers, and the processor is further configured to estimate the first attenuation using amplitudes of the first propagating acoustic wave at the plurality of spaced-apart receivers and to estimate the second attenuation using amplitudes of the second propagating acoustic wave at the plurality of spaced-apart receivers.

14. The apparatus of claim 8, wherein the processor is located at one of: i) a downhole location, and ii) a surface location.

15. A computer-readable medium for use with an apparatus for identifying a micro-annulus outside a casing in a cemented wellbore, the apparatus comprising:
an acoustic wave generator in contact with an inner diameter of the casing configured to propagate a first acoustic wave and a second acoustic wave in the casing;
at least one receiver configured to receive one or both of the first and second acoustic waves upon propagation in the casing; and
the medium comprising instructions which when executed by a processor enable the processor to:
(a) estimate a first attenuation of the first propagating acoustic wave and a second attenuation of the second propagating acoustic wave; and
(b) determine from the first attenuation and the second attenuation a presence of a micro-annulus between the casing and the cement.

16. The medium of claim 15 further comprising at least one of (i) a ROM, (ii) a CD-ROM, (iii) an EPROM, (iv) an EAROM, (v) a flash memory, and (vi) an optical disk.
